(19) United States
(12) Patent Application Publication
(10) Pub. No.: US 2026/0042351 A1
(43) Pub. Date: Feb. 12, 2026

(54) METHOD FOR MAINTAINING OPERATION OF LDC CONVERTER IN COMMUNICATION FAILURE STATE

(71) Applicants: Hyundai Motor Company, Seoul (KR); Kia Corporation, Seoul (KR)

(72) Inventor: Yong-Hyun Kim, Hwaseong-si (KR)

(21) Appl. No.: 19/169,831

(22) Filed: Apr. 3, 2025

(30) Foreign Application Priority Data
Aug. 12, 2024 (KR) 10-2024-0107510

(51) Int. Cl. B60L 3/00; B60L 53/20; H02J 7/00

(52) U.S. Cl. CPC B60L 3/003; B60L 53/20; H02J 7/0029; H02J 2207/20

(57) ABSTRACT

Provided is a method for maintaining the operation of a converter in a communication failure statue. A converter controller is operated depending on an operating state of a vehicle. After a driveable high voltage is applied from a main battery, the converter controller determines whether a command signal from a vehicle controller is present. If the command signal is not present as a result of the determination, the converter controller converts the driveable high voltage to a predetermined self-locking voltage by taking into account a relay operation of a relay circuit.

### CROSS-REFERENCE TO RELATED APPLICATIONS

This application claims priority to Korean Patent Application No. 10-2024-0107510, filed on Aug. 12, 2024, which is incorporated herein by reference in its entirety.

### TECHNICAL FIELD

The present disclosure relates to the operation of a converter and, more particularly, to a method for maintaining the operation of a converter in any user situation after a communication failure.

### BACKGROUND

Currently, auxiliary batteries of approximately 12 V are experiencing a significant increase in the rate of failed discharges. There are a number of possible causes of such failed discharges, one of which is the failure of a converter charging the auxiliary battery of an environmentally friendly vehicle. The converter is typically a direct current to direct current (DC-DC) converter.

There may be a number of reasons why the converter may not start, but a communication failure is one such reason. To address this problem at least in part, a converter uses a logic having a configuration by which the converter may determine a voltage and operate by itself if the communication line of the converter is interrupted in a situation in which a vehicle is currently running, i.e., a situation in which an environmentally friendly vehicle is ready (i.e., the converter is operating).

This is part of a fail-safe logic and helps maintain a 12V charge, but an average driver may want to reset a fault by restarting the vehicle when the fault warning light of the cluster comes on or a fault alarm occurs.

However, none of the current fault recovery logics is configured to restart in the event of a communication failure. Accordingly, the above-described existing technologies suffer from the problem that the logic becomes meaningless when attempting to restart.

### SUMMARY

Accordingly, various aspects of the present disclosure relate to a method for maintaining the operation of a converter in a communication failure state.

To realize the above-described various aspects, the present disclosure provides a method for maintaining the operation of a converter in a communication failure state.

The method includes: operating a converter controller depending on an operating state of a vehicle; after a driveable high voltage is applied from a main battery, determining, by the converter controller, whether a command signal from a vehicle controller is present; and based on no presence of the command signal as a result of the determination, converting, by the converter controller, the driveable high voltage to a predetermined self-locking voltage by taking into account a relay operation of a relay circuit.

The operating state of the vehicle may be a state in which the vehicle has entered an ignition (IG) on state or a ready state.

The converting operation may include, before converting the driveable high voltage to the predetermined self-locking voltage, determining, by the converter controller, whether a BMS signal from a battery management system (BMS) is present.

The converting operation may include checking, by the converter controller, an operation completion signal of a main relay of the relay circuit according to a result of the determination of whether the BMS signal is present.

Based on no completion of the operation of the main relay as a result of the checking of the operation completion signal, the checking of the operation completion signal may include rechecking, by the converter controller, the operation completion signal of the main relay.

The converting operation may include, according to a result of the determination of whether the BMS signal is present, imposing, by the converter controller, a predetermined delay time by taking into account an operation of the main relay based on no presence of the BMS signal.

The predetermined delay time may include at least one of a precharging time, a main relay on time, or a predetermined hardware response time.

The BMS signal may be a signal indicating an on or off of the relay circuit.

The determining operation may include, based on no presence of the command signal as a result of the determination, driving, by the converter controller, a power conversion circuit according to the command signal.

The predetermined self-locking voltage may be stored in a lookup table in advance.

The lookup table may be configured such that the self-locking voltages match respective electrical components.

A converter including the converter controller and a charger configured to charge the main battery may form a single integrated charge controller.

The vehicle controller and the converter controller may be physically separated from each other.

According to the present disclosure, by maintaining the operation of the converter even under conditions such as a communication failure of the converter and a communication failure of the controller, controlled power may be supplied. Accordingly, situations, such as a shutdown of a vehicle or an inability to start a vehicle while driving may be prevented.

Another effect of the present disclosure is that the operation of the converter may be maintained during restart attempts by the driver to recover from a failure.

### BRIEF DESCRIPTION OF THE DRAWINGS

FIG. 1 is a block diagram illustrating a device for maintaining the operation of an LDC converter according to an embodiment of the present disclosure;

FIG. 2 is a block diagram illustrating the specific configuration of the converter shown in FIG. 1;

FIG. 3 is a block diagram illustrating the relay circuit shown in FIG. 1; and

FIG. 4 is a flowchart illustrating a process for maintaining the operation of the converter even during a communication failure according to an embodiment of the present disclosure.

### DETAILED DESCRIPTION OF ILLUSTRATIVE EMBODIMENTS

The above and other objects, features and advantages of the present disclosure will be described later in detail with reference to the accompanying drawings, and thus the technical spirit of the present disclosure can be easily implemented by those skilled in the art. In the following description of the present disclosure, if a detailed description of known configurations and functions is determined to obscure the interpretation of the present disclosure, the detailed description thereof will be omitted.

Hereinafter, example embodiments according to the present disclosure will be described in detail with reference to the accompanying drawings. In the drawings, the same reference numerals refer to the same or similar elements throughout.

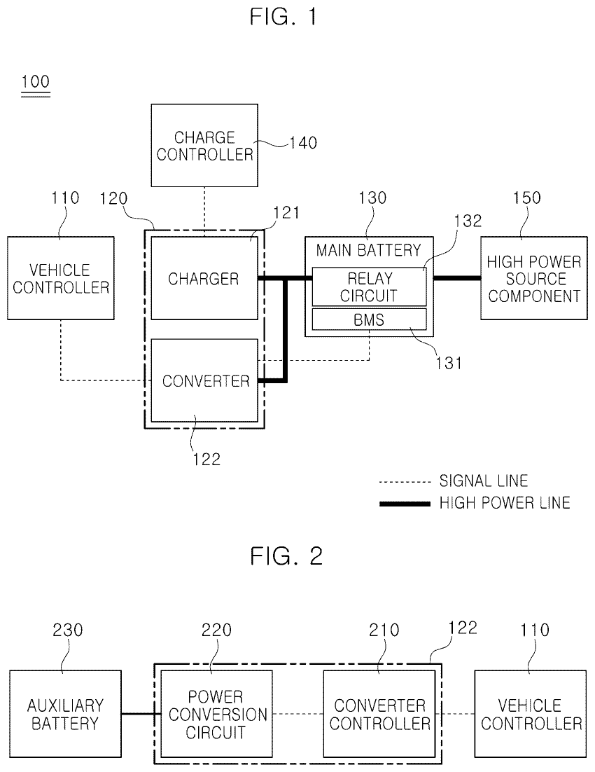

FIG. 1 is a block diagram illustrating a device 100 for maintaining the operation of an LDC converter according to an embodiment of the present disclosure. Referring to FIG. 1, the device 100 for maintaining the operation of an LDC converter may include a vehicle controller 110, an integrated charge controller 120, a main battery 130, a charge controller 140, a high power source component 150, and the like.

The vehicle controller 110 is a higher-level controller performing a plurality of functions by communicating with a plurality of controllers provided in the vehicle. The communication is typically controller area network (CAN) communications, but may be communications based on local interconnect network (LIN), power line communication (PLC), FlexRay, control pilot (CP), and the like.

A function of executing commands received from the driver is also performed. The driver commands may be based on a physical key switch, a key button, a voice, an icon on a touch screen, and the like. Accordingly, the vehicle controller 110 may include a microprocessor, a microcomputer, an electronic circuit, a communication circuit, a memory, and the like.

The integrated charge controller 120 includes a charger 121 and a converter 122. The charger 121 functions to charge the main battery 130 with electricity received from an external power source at a fast or slow rate. The external power source may be electric charging station power or household power. In this regard, the charger 121 converts alternating current (AC) power to direct current (DC) power. The charger 121 may convert a large amount of DC power to a small amount of DC power.

The converter 122 is connected to the output end of the main battery 130 and functions to convert the output to a smaller amount of DC power. Thus, the converter 122 may be a DC-DC converter.

In case that the controller (not shown) of the converter 122 is physically separated from the vehicle controller 110, the converter 122 is more likely to experience poor communication than if it is not physically separated from the vehicle controller 110. More specifically, the probability of occurrence of a bus-off condition, in which the corresponding node is removed from the network, is the same, but the probability of a time-out, in which the communication line is disconnected, is increased. Accordingly, the converter 122 maintains its operation in such a communication failure situation.

Furthermore, using the high voltage of the main battery during an ignition (IG) on state may increase the frequency of use of the converter 122. Accordingly, the operation of the converter 122 is more widely assured.

The main battery 130 includes battery cells (not shown) in series and/or in parallel, which may be high-voltage battery cells for electric vehicles, such as nickel-metal battery cells, lithium-ion battery cells, lithium-polymer battery cells, lithium-sulfur battery cells, sodium-sulfur battery cells, all-solid-state battery cells, or the like. In general, a high-voltage battery is a battery used as a power source to drive an electric vehicle, and refers to a battery having a high voltage capacity of 200V or more.

The main battery 130 may be configured to include a battery management system (BMS) 131, a relay circuit 132, and the like. The BMS 131 and/or the relay circuit 132 may be configured separately from the main battery 130.

The relay circuit 132 performs a function of electrically connecting or electrically disconnecting the main battery 130 and the converter 122. The relay circuit 132 may also perform a function of electrically connecting or electrically disconnecting the main battery 130 and the high power source component 150.

In general, at the moment a contact is established via the relay, the potential difference between the converter 122 or the internal capacitor of the inverter and the main battery 130 may cause an inrush current and a spark, thereby resulting in fusing or burnout of the relay.

Accordingly, the relay circuit 132 also performs a function of delaying an increase in power from the main battery 130 to prevent a sudden current flow, thereby preventing the main relay (not shown) from sticking.

The BMS 131 optimizes battery management for environmentally friendly vehicles to increase energy efficiency and extend the battery life. The BMS 131 monitors battery voltage, current, and temperature in real time and prevents overcharging and overdischarging, thereby improving battery safety and reliability. In this regard, the BMS 131 may include various sensors, microprocessors, switching elements, cell balancers, and the like. The various sensors may be high-voltage pressure sensors, current sensors, voltage sensors, temperature sensors, and the like.

A high power source component 150 is connected to the output end of the relay circuit 132. The high power source component 150 may be a motor (not shown), an inverter (not shown), or the like.

The BMS 131 is connected to the converter 122 to transmit a BMS signal indicating whether the relay circuit 132 is operating.

The charge controller 140 performs a function of controlling the overall operation of the charger 121. In particular, the charge controller 140 performs a function of controlling the overall operation of the charger 121 to perform charging. In FIG. 1, the charging controller 140 is shown as being connected to the charger 121 by a communication line, but this is for understanding the present disclosure, and the charging controller 140 may be communicably connected to the vehicle controller 110 and/or the converter controller (not shown) to perform wireless communications. The charging controller 140 may be configured to include a microcomputer, a microprocessor, a memory, a communication circuit, an electronic circuit, and the like.

FIG. 2 is a block diagram illustrating the specific configuration of the converter 122 shown in FIG. 1. Referring to FIG. 2, the converter 122 includes a converter controller 210, a power conversion circuit 220, and the like.

The converter controller 210 performs a function of turning on and off power switching elements (not shown) provided in the power conversion circuit 220. In this manner, the converter controller 210 performs a function of converting a high voltage (e.g., about 220 V) from the main battery 140 to a low voltage (e.g., about 12 V) and supplying the converted voltage to the auxiliary battery 230. The converter controller 210 may also supply the voltage directly to the load. The converter controller 210 may be configured to include a microcomputer, a microprocessor, a memory, a communication circuit, an electronic circuit, and the like.

The power conversion circuit 220 includes a full bridge (not shown) converting a DC voltage from the main battery 130 to a high frequency AC voltage, a transformer (not shown) transforming the AC voltage, a rectifier (not shown) converting the transformed AC voltage to a DC voltage, and the like. A high voltage system and a low voltage system may be isolated by the transformer.

A power transistor may typically be used in the full bridge (not shown), and a diode may be used in the rectifier (not shown). This is not intended to be limiting, and other power switching elements may be used.

The auxiliary battery 230 is charged by the power conversion circuit 220 and performs the function of supplying power to low power electrical components. More specifically, when the relay circuit 132 is turned on, charging is performed by converting a high voltage from the main battery 140 to a low voltage by the power conversion circuit 220.

In FIG. 2, a solid line between the power conversion circuit 220 and the secondary battery 230 represents a low power line.

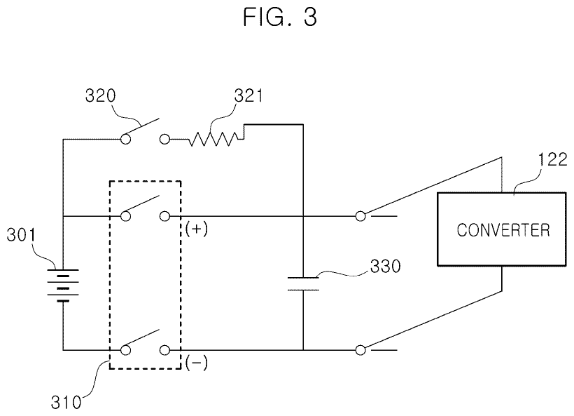

FIG. 3 is a block diagram illustrating the relay circuit 132 shown in FIG. 1. Referring to FIG. 3, the relay circuit 132 includes a main relay 310 and a precharge relay 320. The precharge relay 320 is configured in parallel with the main relay 310.

The precharge relay 320 also includes a resistor 321 configured in series and a capacitor 330 connected to the mail relay 310 and the resistor 320. The capacitor 330 is connected in parallel to a multi-battery cell 301 provided in the main battery 130. The multi-battery cell 301 represents a plurality of battery cells connected in series.

The precharge relay 320 also performs a function of delaying an increase in power from the multi-battery cell 301 provided in the main battery 130 to prevent a rapid current flow, thereby preventing the main relay (not shown) from sticking.

Referring to FIG. 3, a precharge state is achieved when the precharge relay 320 is turned on and the main relay 310 is turned off. At this time, the (−) side of the main relay 310 is turned on. In the precharge state, the voltage across the main relay 310 and the voltage across the capacitor 330 are approximately equal.

Thereafter, when the precharge relay 320 is turned off and the mail relay 310 is turned on, power is supplied from the multi-battery cell 301 to the converter 122.

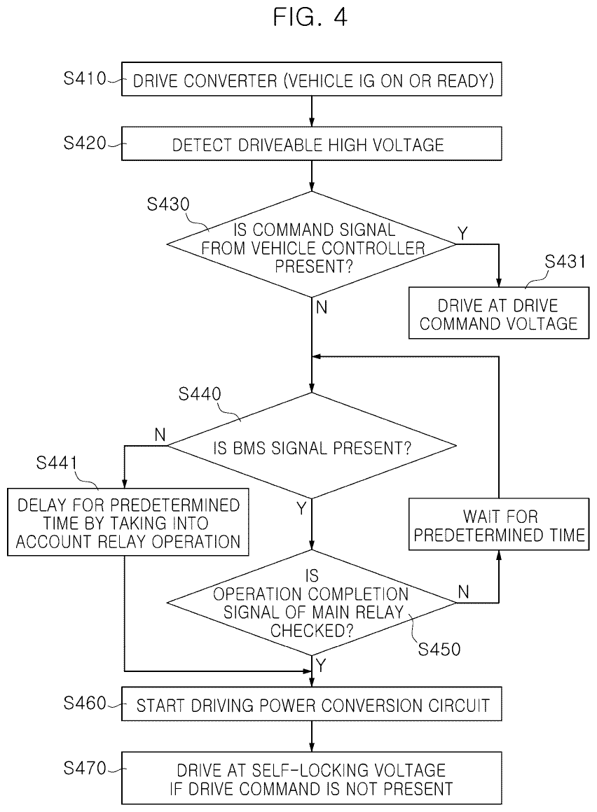

FIG. 4 is a flowchart illustrating a process for maintaining the operation of the converter 122 even during a communication failure according to an embodiment of the present disclosure. Referring to FIG. 4, in operation S410, the converter 122 is driven when the vehicle is in an ignition (IG) on state or a ready state. More specifically, in the IG on state or the ready state, power is supplied from the main battery 130 to the electrical components of the vehicle. Accordingly, the converter controller 210 provided in the converter 122 enters an operating state.

In general, there are IG off, ACC, IG on, and ready states, in which the IG off state is a state in which all power to the vehicle is turned off, such as when the vehicle is parked, and the ACC state is a state in which only accessory devices of the vehicle are powered.

Furthermore, the IG on state is a state in which the motor (not shown) is not powered, but only the various electrical components of the vehicle are powered by the auxiliary battery 230, and the ready state is a startup state in which the vehicle may be driven by powering the motor (not shown) when the brake is applied and the start button is selected.

Thereafter, the converter controller 210 detects a driveable high voltage being applied from the main battery 130 in operation S420. More specifically, the converter controller 210 determines whether a high voltage is input from the main battery 130. Typically, the lowest driveable high voltage for driving the power conversion circuit 220 may be about 200 volts. More specifically, the driveable voltage is equal to or greater than the minimum driveable voltage level of the converter 122 within the normal drive voltage range of the main battery 130, which is a high voltage battery.

Thereafter, the converter controller 210 determines whether a command signal from the vehicle controller 110 is present or not in operation S430. More specifically, the converter controller 210 determines whether the command signal indicating a drive command voltage for driving the low power electrical components is present.

If the command signal from the vehicle controller 110 is present as a result of the determination in operation S430, the converter controller 210 drives the power conversion circuit 220 with a driveable voltage according to the command signal in operation S431. More specifically, the detected driveable high voltage is generated by the command signal from the vehicle controller 110, and the power conversion circuit 220 is driven according to the detected driveable high voltage.

In another example, if the command signal from the vehicle controller 110 is not present (i.e., no presence of the command signal) as a result of the determination in operation S430, the vehicle controller 110 determines whether a BMS signal from the BMS 131 is present in operation S440. More specifically, the BMS 131 generates a BMS signal (or a relay signal) by monitoring the on/off of the main relay 310 of the relay circuit 132 and transmits the BMS signal to the converter controller 210.

If the BMS signal from the BMS 131 is present as a result of the determination in operation S440, it is determined whether an operation completion signal of the main relay 310 is checked in operation S450. More specifically, it is checked whether an operation completion signal of the main relay 310 from the BMS signal is present.

The operation completion signal means that the main relay 310 is fully turned on after the precharge relay 320 is turned off. For example, because operation of the converter 122 during precharging may cause a burnout in the relay circuit 132, operation through the power conversion circuit 220 is required after the precharging operation is completed.

If the operation completion signal of the main relay 310 is checked as a result of the determination in operation S450, the converter controller 210 starts driving the power conversion circuit 220 and converts the voltage to a predetermined self-locking voltage in operations S460 and S470. More specifically, driving is performed at the predetermined self-locking voltage due to the absence of a drive command from the vehicle controller 110. Because the self-locking voltage differs depending on the electrical components, the self-locking voltage is selected in advance using a lookup table. The lookup table may be configured such that the self-locking voltages match respective electrical components.

In another example, if the operation completion signal of the main relay 310 is not checked as a result of the determination in operation S450, operation S450 is performed again in real time. A predetermined waiting time may be set, and the operation completion signal may be checked after the waiting time has elapsed. More specifically, the predetermined waiting time may be set by taking into account that a predetermined amount of time must elapse from the precharging to the generation of the operation completion signal of the main relay 310 due to the completion of the on operation of the main relay 310.

If the BMS signal from the BMS 131 is not present (i.e., no presence of the BMS signal) as a result of the determination in operation S440, the converter controller 210 imposes a predetermined delay time by taking into account the operation of the main relay 310 in operation S441. More specifically, if the BMS signal is not present, the converter controller 210 performs the operation thereof with the predetermined delay time.

Accordingly, when a high voltage is applied to the converter 122 without a command from the vehicle controller 110, the converter 122 performs the operation thereof, taking into account the precharging operation time of the relay circuit 132.

Reflecting the precharging operation time, the predetermined delay time may be expressed as follows:

Delay Time=Precharging time+Main Relay on Time+Hardware Response Time

For example, the precharging time may be about 330 ms, the main relay on time may be about 100 ms, and the hardware response time may be about 600 ms. In this case, the delay time may be about 1 second.

The hardware response time is a value that is calculated in advance by taking into account the responsiveness of the hardware, including hardware-to-hardware variations and sequence delays in reaching hardware. The hardware response time may also be calculated using a plurality of experimental results.

The delay time may also be calculated using a combination of a precharging time, a main relay on time, and a calibration value.

Therefore, after the converter controller 210 is turned on in response to the IG on or ready state, if the driveable high voltage detected by the input sensor configured in the converter controller 210 is a predetermined level or higher, the power conversion circuit 220 of the converter 122 is driven and converted to a self-locking voltage by reflecting the precharging operation time in operations S460 and S470.

More specifically, driving to the self-locking voltage means locking voltage control for charging the secondary battery 230, which may be as low as about 13.5 volts.

Variable output voltage control of a low voltage DC-DC converter (LDC) may help improve fuel economy but be more effective in providing stable voltage than fuel economy in a situation in which communication is impossible.

In addition, the operations of the methods or algorithms described in connection with the embodiments disclosed hereinabove may be implemented in the form of program instructions executable by various computer means, such as a microprocessor, a processor, a central processing unit (CPU), or the like, for recording on a computer-readable medium. The computer-readable medium may include one or a combination of program (instruction) code, a data file, a data structure, and the like.

What is claimed is:

1. A method for maintaining operation of an LDC converter in a communication failure state, the method comprising:
operating a converter controller depending on an operating state of a vehicle;
after a driveable high voltage is applied from a main battery, determining, by the converter controller, whether a command signal from a vehicle controller is present; and
based on no presence of the command signal as a result of the determination, converting, by the converter controller, the driveable high voltage to a predetermined self-locking voltage by taking into account a relay operation of a relay circuit.

2. The method of claim 1, wherein the operating state of the vehicle is a state in which the vehicle has entered an ignition (IG) on state or a ready state.

3. The method of claim 1, wherein converting the driveable high voltage to the predetermined self-locking voltage comprises, before converting the driveable high voltage to the predetermined self-locking voltage, determining, by the converter controller, whether a BMS signal from a battery management system (BMS) is present.

4. The method of claim 3, wherein converting the driveable high voltage to the predetermined self-locking voltage comprises checking, by the converter controller, an operation completion signal of a main relay of the relay circuit according to a result of the determination of whether the BMS signal is present.

5. The method of claim 4, wherein converting the driveable high voltage to the predetermined self-locking voltage comprises, according to the result of the determination of whether the BMS signal is present, imposing, by the converter controller, a predetermined delay time by taking into account an operation of the main relay based on no presence of the BMS signal.

6. The method of claim 5, wherein the predetermined delay time comprises at least one of a precharging time, a main relay on time, or a predetermined hardware response time.

7. The method of claim 3, wherein the BMS signal comprises a signal indicating an on or off of the relay circuit.

8. The method of claim 1, wherein the predetermined self-locking voltage is stored in advance.

9. The method of claim 1, wherein determining whether the command signal from the vehicle controller is present comprises:
based on no presence of the command signal as the result of the determination, driving, by the converter controller, a power conversion circuit according to the command signal.

10. A system for maintaining operation of an LDC converter in a communication failure state, the system comprising:
one or more processors; and
one or more non-transitory computer readable media storing instructions which, when executed by the one or more processors, cause the one or more processors to:
after a driveable high voltage is applied from a main battery, determine, by a converter controller, whether a command signal from a vehicle controller is present; and
based on no presence of the command signal as a result of the determination, convert, by the converter controller, the driveable high voltage to a predetermined self-locking voltage by taking into account a relay operation of a relay circuit.

11. The system of claim 10, wherein an operating state of a vehicle comprising the system is an ignition (IG) on state or a ready state.

12. The system of claim 10, wherein, to convert the driveable high voltage, execution of the instructions further cause the one or more processors to:
before converting the driveable high voltage to the predetermined self-locking voltage, determine, by the converter controller, whether a BMS signal from a battery management system (BMS) is present.

13. The system of claim 12, wherein, to convert the driveable high voltage, execution of the instructions further cause the one or more processors to:
check, by the converter controller, an operation completion signal of a main relay of the relay circuit according to a result of the determination of whether the BMS signal is present.

14. The system of claim 13, wherein, to convert the driveable high voltage, execution of the instructions further cause the one or more processors to:
according to the result of the determination of whether the BMS signal is present, impose, by the converter controller, a predetermined delay time by taking into account an operation of the main relay based on no presence of the BMS signal.

15. The system of claim 14, wherein the predetermined delay time comprises at least one of a precharging time, a main relay on time, or a predetermined hardware response time.

16. The system of claim 12, wherein the BMS signal comprises a signal indicating an on or off of the relay circuit.

17. The system of claim 10, wherein the predetermined self-locking voltage is stored in advance.

18. The system of claim 10, wherein, to determine whether the command signal from the vehicle controller is present, execution of the instructions further causes the one or more processors to:
based on no presence of the command signal as the result of the determination, drive, by the converter controller, a power conversion circuit according to the command signal.

19. A non-transitory computer-readable medium storing programming for execution by one or more processors, the programming comprising instructions to:
after a driveable high voltage is applied from a main battery, determine, by a converter controller, whether a command signal from a vehicle controller is present; and
based on no presence of the command signal as a result of the determination, convert, by the converter controller, the driveable high voltage to a predetermined self-locking voltage by taking into account a relay operation of a relay circuit.

20. The non-transitory computer-readable medium of claim 19, wherein, to convert the driveable high voltage, the programming comprises further instructions to:
before converting the driveable high voltage to the predetermined self-locking voltage, determine, by the converter controller, whether a BMS signal from a battery management system (BMS) is present.
